(19) United States
(12) Patent Application Publication
(10) Pub. No.: US 2020/0386116 A1
(43) Pub. Date: Dec. 10, 2020

(54) TURBOCHARGER

(71) Applicant: MAN Energy Solutions SE, Augsburg (DE)

(72) Inventors: Hannes BENETSCHIK, Munchen (DE); Alfons BORNHORN, Aystetten (DE); Christoph HEINZ, Langenau (DE)

(21) Appl. No.: 16/857,318

(22) Filed: Apr. 24, 2020

(30) Foreign Application Priority Data
Apr. 25, 2019 (DE) 10 2019 110 671.0

(51) Int. Cl. F01D 17/16; F01D 9/04; F01D 17/14; F01D 25/16; F01D 25/24; F02B 37/24; F02C 6/12; F02M 35/12

(52) U.S. Cl. CPC F01D 17/165; F01D 9/04; F01D 17/143; F01D 25/16; F01D 25/246; F05D 2230/64; F02C 6/12; F02M 35/12; F05D 2220/40; F05D 2230/53; F02B 37/24

(57) ABSTRACT

A turbocharger, having a turbine and a compressor. The turbine comprises a turbine housing and a turbine rotor with turbine blades. Radially outer edges of the rotor blades and a portion of the turbine housing or a stator-side component connected to the turbine housing define a turbine-side gap. The compressor comprises a compressor housing and a compressor rotor with compressor blades. Radially outer edges of the compressor blades and a portion of the compressor housing facing the compressor blades or a stator-side component connected to the compressor housing define a compressor-side gap. The portion of the turbine housing facing the turbine rotor blades or the stator-side component connected to the turbine housing and/or the portion of the compressor housing facing the compressor rotor blades or the stator-side component connected to the compressor housing comprises a running-in structure comprising hollow spaces.

### BACKGROUND OF INVENTION

### 1. Field of the Invention

The invention relates to turbocharger.

### 2. Description of Related Art

FIG. 1 shows the fundamental construction of a turbocharger 1 known from practice. A turbocharger 1 comprises a turbine 2 for expanding a first medium, in particular for expanding exhaust gas of an internal combustion engine. During the expansion of the first medium energy is extracted. Furthermore, the turbocharger 1 comprises a compressor 3 for compressing a second medium, in particular charge air to be supplied to an internal combustion engine, namely utilising the energy extracted in the turbine 2 during the expansion of the first medium.

The turbine 1 comprises a turbine housing 4 and a turbine rotor 5. The compressor 3 comprises a compressor housing 6 and a compressor rotor 7. Turbine rotor 5 and compressor rotor 7 are coupled via a shaft 8 which is mounted in a bearing housing 9. The bearing housing 9 is connected on the one hand to the turbine housing 4 and on the other hand to the compressor 6.

Furthermore, FIG. 1 shows an optional silencer 10 connected to the compressor housing 6, wherein charge air is conducted via the silencer 10.

The turbine housing 4 comprises an inflow housing 11 and an outflow housing 12. By way of the inflow housing 11, the first medium to be expanded is supplied to the turbine rotor 5, here in the radial direction. By way of the outflow housing 12, the expanded first medium can be discharged from the turbine rotor 5, here in the axial direction. The turbine of FIG. 1 is a radial turbine.

Furthermore, FIG. 1 shows an insert piece 13 and a nozzle ring 15 as component parts of the turbine housing 4. The insert piece 13, which is a stator-side assembly of the turbine 2 connected to the turbine housing, follows turbine rotor blades 14 of the turbine rotor 5 radially outside and delimits a flow passage of the inflow housing 11 at least in sections. Radially outer edges 14a of the turbine rotor blades 14 and a portion of the turbine housing 4 facing the turbine rotor blades 14 or of the insert piece 13 connected to the turbine housing 4 define a turbine-side gap between the turbine rotor blades 14 and the stator of the turbine 2.

The compressor rotor 7, which in FIG. 1 is embodied as radial compressor, carries compressor rotor blades 16. Radially outer edges 16a of the compressor rotor blades 16 and a portion of the compressor housing 6 facing the compressor rotor blades 16 or a stator-side component connected to the compressor housing define a compressor-side gap between the compressor rotor blades 16 and the stator of the compressor 2.

A turbocharger according to FIG. 1 is known from DE 10 2016 125 189 A1.

In order to provide as high as possible an efficiency for the turbocharger it is desirable to form the turbine-side gap between the turbine rotor blades and the stator of the turbine as well as the compressor-side gap between the compressor rotor blades and the stator of the compressor as small as possible. However, during the operation of the turbocharger there is the risk that in particular in the region of the turbine as a consequence of centrifugal forces acting on the turbine rotor and as a consequence of thermally-induced strains of the turbine rotor the turbine rotor blades run into the stator. Because of this, the respective rotor blades can then be damaged. This is a disadvantage.

From DE 10 2015 016 486 A1 a turbocharger is known, in which in the region of the turbine the insert piece has a defined contouring to prevent the turbine rotor blades of the turbine rotor running into the insert piece.

### SUMMARY OF THE INVENTION

There is a need for a new type of turbocharger in which in the region of the turbine and/or of the compressor small gap dimensions for the gap between the turbine rotor blades and/or the compressor rotor blades and a stator of the turbine and/or of the compressor can be adjusted, namely without the risk that in the event of the rotor blades running into the stator the respective rotor blades are damaged.

One aspect of the present invention is a new type of turbocharger. According to one aspect of the invention, the portion of the turbine housing facing the turbine rotor blades or of the stator-side component connected to the turbine housing and/or the portion of the compressor facing the compressor rotor blades or of the stator-side component connected to the compressor housing carries a running-in structure comprising hollow spaces. With one aspect of the invention present here it is proposed for the first time that the portion of the turbine housing facing the turbine rotor blades or of stator-side component connected to the turbine housing and/or the portion of the compressor housing facing the compressor rotor blades or of the stator-side component connected to the compressor housing carries running-in structure with hollow spaces. When the rotor blades for example as a consequence of centrifugal forces acting during the operation and/or as a consequence of thermal strains run into the running-in structure, the running-in structure gives way so that the respective rotor blades are not subjected to any risk of damage. Thus, a minimum gap can be adjusted between the edges of the respective rotor blades and the respective stator of the turbine without risk of damage to the respective rotor blades during the operation of the turbocharger.

According to a further development of the invention, the running-in structure is formed open-pored or open-celled in such a manner that the hollow spaces of the running-in structure are formed open in the direction of the respective rotor blades or facing the respective rotor blades. Such an open-pored or open-celled running-in structure is particularly preferred in order to adjust a minimum gap between the rotor blades and the stator-side running-in structure in particular when the rotor blades run into the running-in structure without risk of damage for the rotor blades and for the running-in structure.

According to a further development of the invention, the running-in structure comprises honeycomb-like hollow spaces. Honeycomb-like hollow spaces for the stator-side running-in structure are particularly preferred in order to adjust a minimum gap between the rotor blades and the respective stator without risk of damage for the rotor blades and for the running-in structure during the operation. Here, the inventors understand honeycomb-like hollow spaces to also include surface structures such as present on golf balls. By way of this, the optimisation of the efficiency can be achieved since because of this as thin as possible turbulent boundary layer can be formed.

According to a further development of the invention, walls of the running-in structure have a maximum wall thickness of 0.2 mm. Such thin walls of the running-in structure are particularly flexible and make possible adjusting a minimum gap between the rotor blades and the respective stator without risk of damage for the rotor blades and for the running-in structure during the operation.

Preferred further developments of the invention are obtained from the following description. Exemplary embodiments of the invention are explained in more detail by way of the drawing without being restricted to this.

### BRIEF DESCRIPTION OF THE DRAWINGS

There it shows:

FIG. 1: is a cross section through a turbocharger known from practice;

FIG. 2: is a cross section through a turbocharger in a region of a turbine of the turbocharger designed as radial turbine;

FIG. 3: is a cross section through a turbocharger in a region of a turbine of the turbocharger formed as axial turbine; and

FIG. 4: the detail A-A of FIG. 2, 3.

### DETAILED DESCRIPTION OF THE PRESENTLY PREFERRED EMBODIMENTS

A turbocharger 1 comprises a turbine 2 for expanding a first medium, in particular for expanding exhaust gas of an internal combustion engine. Furthermore, a turbocharger 1 comprises a compressor 3 for compressing a second medium, in particular charge air, namely utilising energy extracted in the turbine 2 during the expansion of the first medium.

The turbine 2 comprises a turbine housing 4 and a turbine rotor 5. The compressor 3 comprises a compressor housing 6 and a compressor rotor 7. The compressor rotor 7 is coupled to the turbine rotor 5 via a shaft 8 mounted in a bearing housing 9, wherein the bearing housing 9 is positioned between the turbine housing 4 and the compressor housing 5 and connected both to the turbine housing 4 and the compressor housing 5.

Typically, the turbine housing 4 comprises an inflow housing 11 and an outflow housing 12. By way of the inflow housing 11, which is connected to the bearing housing 9, the first medium to be expanded can be conducted onto the turbine rotor 5. By way of the outflow housing 12, which is connected to the inflow housing 11, expanded first medium can be discharged from the turbine rotor 5. Typically, the turbine housing 4 furthermore comprises an insert piece 13 and a nozzle ring 15. The insert piece 13 delimits a flow passage for the first medium in sections, wherein the insert piece 13 follows rotor blades 14 of the turbine rotor 5 radially outside. Upstream of the turbine rotor 5, the nozzle ring 15 is positioned, which serves for the flow conduction of the first medium to be expanded upstream of the turbine rotor 5.

Accordingly, the turbine rotor 5 carries the turbine rotor blades 14, wherein between radially outer edges 14a of the turbine rotor blades 14 and a stator-side assembly following radially outside, typically the stator-side insert piece 13, which is connected to the turbine housing 4, a gap is formed.

Such a gap is also formed in the region of the compressor 3 between compressor rotor blades 16 of the compressor rotor 7 and the compressor housing 6 following the compressor rotor 7 radially outside, in particular between the outer edges 16a of the compressor rotor blades 16 and a portion of the compressor housing 6 facing the compressor rotor blades 16 or a stator-side component connected to the compressor housing 6.

With one aspect of the invention present here it is now proposed that for forming a minimum turbine-side gap between the turbine rotor blades 14 and the stator of the turbine 2 and/or for forming a minimal compressor-side gap between the compressor rotor blades 16 and the adjacent stator of the compressor 3 the portion of the turbine housing 4 facing the turbine rotor blades 14 or of the stator-side component connected to the turbine housing and/or the portion of the compressor housing 6 facing the compressor rotor blades 16 or of the stator-side component connected to the compressor housing 6, carries a running-in structure 17 that comprises hollow spaces 18.

During operation, the rotor blades 14 and 16 respectively with their radially outer edges 14a and 16a respectively can run into this running-in structure 17, namely without risk of damage for the rotor blades 14 and 16 respectively, so that during the operation a minimal gap is then formed between the rotor blades 14 and 16 respectively and the respective adjacent stator and the stator-side running-in structure 17 respectively. By way of this, a high efficiency can be realised for the turbocharger.

The running-in structure 17 is preferentially formed open-pored or open-celled, namely in such a manner that the hollow spaces 18 of the running-in structure 17 in the direction of the respective rotor blade 14 and 16 respectively are formed open.

Preferentially, the running-in structure is formed honeycomb-like, the same then comprises honeycomb-like hollow spaces 18.

The hollow spaces 18 of the running-in structure 17 are delimited or defined by walls 19 which preferentially have a maximum wall thickness of -k -b 0.2 mm and a minimal wall thickness of 0.05 mm. Such a running-in structure 17 is particularly flexible. Damage to the rotor blades and the running-in structure 17 during the running-in or rubbing of the rotor blades in/on the running-in structure 17 can thus be avoided.

In the region of the turbine 2, the running-in structure 17 is preferentially produced from a highly heat-resistant steel, in particular from a steel of a nickel base alloy or nickel chromium base alloy. Here, X12 steels or X22 steels can be employed in particular.

In the region of the compressor 3, the respective running-in structure 17 can consist of a grey cast iron material or of an aluminium material.

Preferentially, the respective running-in structure 17 is put onto the stator-side component carrying the running-in structure 17 by way of an additive manufacturing method, such as for example 3D printing.

As already explained, the running-in structure 17 can be utilised both in the region of the turbine 2 of the turbocharger 1 and also in the region of the compressor 3 of the turbocharger 1.

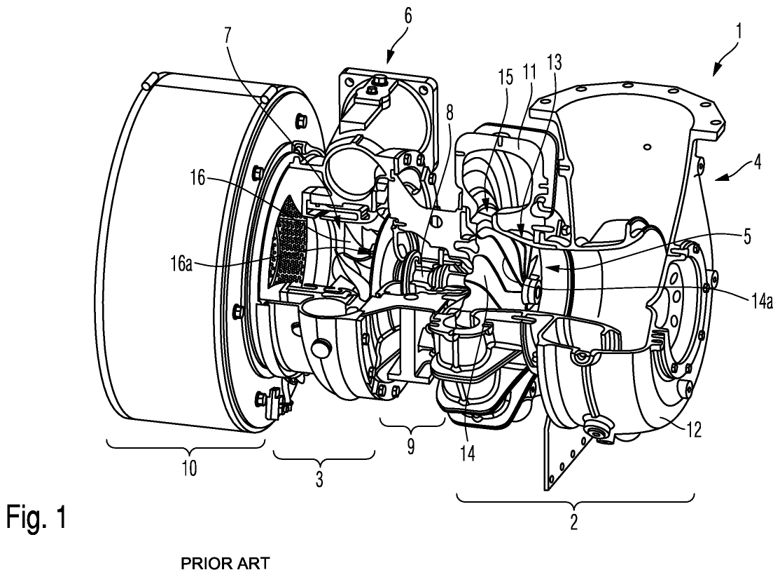

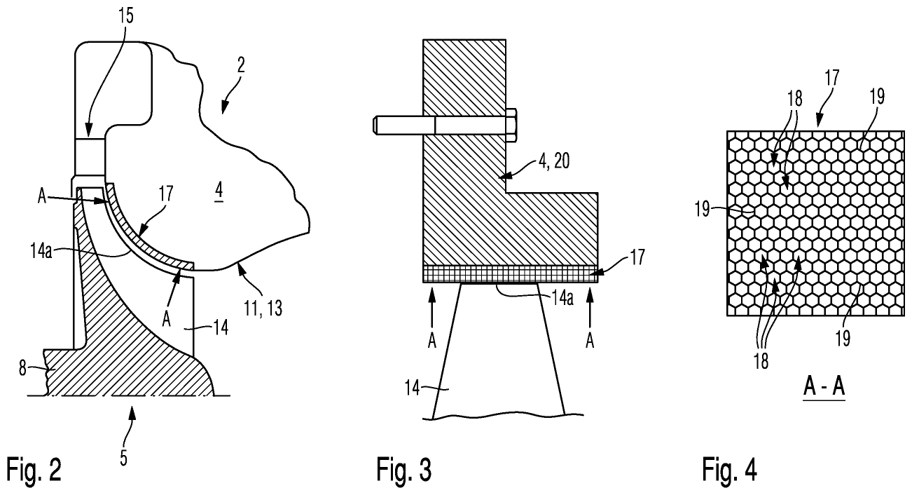

As shown in FIGS. 1 and 2, the turbine 2 can be a radial turbine. It is also possible that the turbine 2 is an axial turbine. FIG. 3 shows an extract from an axial turbine in the region of the rotor blades 14 of the turbine, wherein the turbine housing 4 or a stator-side assembly 20 connected to the turbine housing 4 in turn comprises the running-in structure 17 with the hollow spaces 18 on a portion facing the rotor blades 14.

The invention can also be realised on a compressor, for example on a radial compressor or on an axial compressor of a turbocharger.

With the invention it is possible to increase the efficiency of a turbocharger 1. Both in the region of the turbine 2 and also in the region of the compressor 3 of the turbocharger 1, minimal gaps can be adjusted between the rotor blades 14 and 16 respectively of turbine 2 and compressor 3 respectively and a stator-side component following radially outside. For the rotor blades 14 and 16 respectively there is no risk of damage when rubbing against or running-in into the running-in structure 17. The running-in structure 17 is embodied relatively soft or flexible. During the running-in or rubbing of the rotor blades 14 and 16 respectively, there is no risk of damage for the rotor blades 14 and 16 respectively, and the running-in structure 17 is damaged neither in the circumferential direction nor in the flow direction. Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A turbocharger, comprising:
a shaft;
a turbine configured to expand a first medium comprising:
a turbine housing;
a turbine rotor;
turbine rotor blades of the turbine rotor; and
a turbine-side gap defined between radially outer edges of the turbine rotor blades and a portion of the turbine housing facing the turbine rotor blades or a stator-side component connected to the turbine housing;
a compressor configured to compress a second medium utilizing energy extracted in the turbine during expansion of the first medium, the compressor comprising:
a compressor housing;
a compressor rotor:
compressor rotor blades of the a compressor rotor coupled to the turbine rotor via the shaft; and
a compressor-side gap defined between radially outer edges of the compressor rotor blades and a portion of the compressor housing facing the compressor rotor blades or a stator-side component connected to the compressor housing;
a bearing housing arranged between and connected to the turbine housing and the compressor housing and in which the shaft is mounted; and
a running-in structure comprising hollow spaces is at least one of:
the portion of the turbine housing facing the turbine rotor blades or the stator-side component connected to the turbine housing and
the portion of the compressor housing facing the compressor rotor blades or of the stator-side component connected to the compressor housing.

2. The turbocharger according to claim 1, wherein the running-in structure is formed open-pored or open-celled such a that the hollow spaces of the running-in structure facing in a direction of the respective rotor blades or the respective rotor blades are formed open.

3. The turbocharger according to claim 1, wherein the running-in structure comprises honeycomb-like hollow spaces.

4. The turbocharger according to claim 1, wherein walls of the running-in structure have a maximum wall thickness of 0.2 mm.

5. The turbocharger according to claim 1, wherein the running-in structure in a region of the turbine comprises a highly heat-resistant steel.

6. The turbocharger according to claim 1, wherein the running-in structure in a region of the compressor comprises one of a grey cast iron material and an aluminium material.

7. The turbocharger according to claim 1,
wherein the turbine is an axial turbine, and
wherein the portion of the turbine housing facing the turbine rotor blades of the axial turbine or of the stator-side component connected to the same carries the running-in structure.

8. The turbocharger according to claim 1,
wherein the turbine is a radial turbine, and
wherein the portion of the turbine housing facing the turbine rotor blades of the radial turbine or of the stator-side component connected to the same carries the running-in structure.

9. The turbocharger according to claim 1,
wherein the compressor is a radial compressor, and
wherein the portion of the compressor housing facing the compressor rotor blades of the radial compressor or of the stator-side component connected to the same carries the running-in structure.
